(19) United States
(12) Patent Application Publication
(10) Pub. No.: US 2025/0108257 A1
(43) Pub. Date: Apr. 3, 2025

(54) INFORMATION PROCESSING DEVICE, INFORMATION PROCESSING METHOD, PROGRAM, AND INFORMATION ANALYSIS SYSTEM

(71) Applicant: SONY GROUP CORPORATION, TOKYO (JP)

(72) Inventors: AYAKO AKAMA, TOKYO (JP); KENTARO INO, TOKYO (JP)

(21) Appl. No.: 18/727,838

(22) PCT Filed: Dec. 22, 2022
(86) PCT No.: PCT/JP2022/047345

§ 371 Date: Jul. 10, 2024

(30) Foreign Application Priority Data
Jan. 21, 2022 (JP) 2022-007747

(51) Int. Cl. A63B 24/00; G06T 7/20; G06T 7/70

(52) U.S. Cl. CPC A63B 24/0062; G06T 7/20; G06T 7/70; A63B 2220/05; A63B 2220/30; G06T 2207/30196; G06T 2207/30221

(57) ABSTRACT

An information processing device includes an exercise load calculation unit that performs processing of calculating a value of an exercise load of a subject on the basis of skeleton capture data regarding the subject generated from an image captured by an imaging device.

### TECHNICAL FIELD

The present technology relates to an information processing device, an information processing method, a program, and an information analysis system, and more particularly relates to a technical field of performing analysis processing using information obtained from images.

### BACKGROUND ART

During these years, various analyses are conducted on plays of players of sports such as soccer and basketball to help with practice and match strategies.

For example, a GPS receiver is mounted on a uniform or the like of a player, and a covered distance of the player during a match is measured to obtain an exercise load of the player.

In addition, Patent Document 1 below discloses a technique with which a target moving image and a comparative moving image can be selected from among a plurality of moving images obtained by capturing images of an action of a person who performs a ball game and a skill level of the action, improvement points in mechanics, and the like can be easily grasped.

### CITATION LIST

### Patent Document

Patent Document 1: Japanese Patent Application Laid-Open No. 2021-145702

### SUMMARY OF THE INVENTION

### Problems to be Solved by the Invention

For example, in a case where an exercise load of an athlete needs to be measured in real time and the coach needs to be able to check the exercise load, a certain level of accuracy of the calculation is required.

A covered distance may be measured using the GPS as described above, but obtaining of a load only from a covered distance is not suitable for a competition involving various motions. For example, in soccer, basketball, and the like, various motions are performed in addition to running, and an exercise load applied to a player is different between modes of motion, that is, exercise. An exercise load obtained only from a covered distance, therefore, is not necessarily an accurate exercise load of each player.

The present disclosure, therefore, proposes a technique with which a more accurate exercise load can be obtained.

### Solutions to Problems

An information processing device according to the present technology includes an exercise load calculation unit that performs processing of calculating a value of an exercise load of a subject on the basis of skeleton capture data regarding the subject generated from an image.

A motion and a posture of a subject can be determined using skeleton capture data regarding the subject obtained from an image. An exercise load of the subject is calculated on the basis of the motion and the posture.

### BRIEF DESCRIPTION OF DRAWINGS

FIG. 1 is a diagram illustrating an information analysis system of an embodiment of the present technology.

FIG. 2 is a block diagram of the information analysis system according to the embodiment.

FIG. 3 is a block diagram of an information processing device included in the information analysis system according to the embodiment.

FIG. 4 is a diagram illustrating an analysis dashboard according to the embodiment.

FIG. 5 is a diagram illustrating an exercise load information presented in the embodiment.

FIG. 6 is a diagram illustrating a process for calculating an exercise load according to the embodiment.

FIG. 7 is a flowchart of a process for calculating an exercise load according to the embodiment.

FIG. 8 is a flowchart of a process for obtaining weather information according to the embodiment.

FIG. 9 is a flowchart of a process for setting an initial value according to the embodiment.

FIG. 10 is a flowchart of a process for generating and transmitting exercise load information according to the embodiment.

FIG. 11 is a diagram illustrating a process for predicting an exercise load according to the embodiment.

FIG. 12 is another diagram illustrating the process for predicting an exercise load according to the embodiment.

FIG. 13 is a diagram illustrating how the analysis dashboard is displayed in the embodiment.

FIG. 14 is a diagram illustrating information regarding a player's field of view according to the embodiment.

FIG. 15 is a diagram illustrating an example of how information regarding players' fields of view is displayed in the embodiment.

FIG. 16 is a diagram illustrating an example of how the number of swings of players' heads is displayed in the embodiment.

### MODE FOR CARRYING OUT THE INVENTION

An embodiment will be described hereinafter in the following order.
<1. Configuration of Information Analysis System>
<2. Example of How Analysis Dashboard Is Displayed>
<3. Calculation and Display of Exercise Load>
<4. Example of How Display of Analysis Dashboard Is Controlled>
<5. Analysis and Display of Players' Fields of View>
<6. Conclusion and Modifications>

### 1. Configuration of Information Analysis System

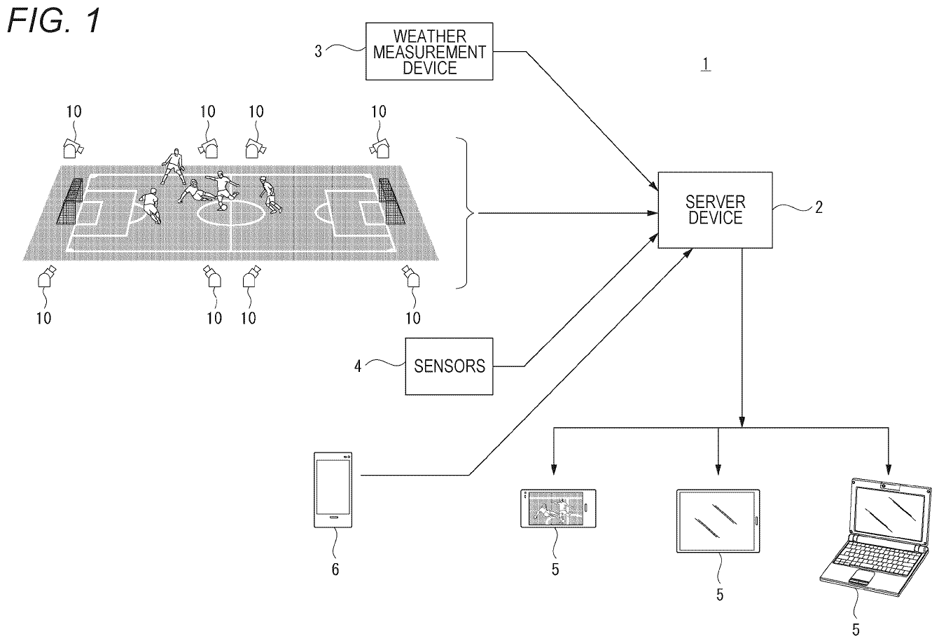

FIG. 1 illustrates an outline of the information analysis system 1 according to the embodiment.

The information analysis system 1 in FIG. 1 includes imaging devices 10, a server device 2, a weather measurement device 3, sensors 4, terminal devices 5, and terminal devices 6. These components are connected to one another via wired communication, wireless communication, network communication, or the like.

For example, the plurality of imaging devices 10 captures images of an area of subjects in a sports venue or the like for soccer or the like, such as a stadium where a match is being played, from various positions. Although a plurality of imaging devices 10 is illustrated, at least one imaging device 10 may be provided.

In the information analysis system 1 according to the present embodiment, skeleton capture data regarding subjects such as players is extracted from images captured by the imaging devices 10, and postures, positions, movement, and the like of the players or the like are estimated on the basis of the skeleton capture data.

During these years, with regard to plays in sports such as soccer and basketball, a technique for estimating postures and positions of players and referees, a position and rotation of a ball, and the like from a specified field on the basis of images captured by dedicated cameras and information obtained by sensors (acceleration sensors and GPS sensors) attached to persons (players) and an object (ball) involved in the competition is known as Electronic Performance and Tracking Systems (EPTS).

More specifically, the imaging devices 10 capture images for obtaining such EPTS data as skeleton capture data.

The images captured by the imaging devices 10 can also be used as real images of a match or the like.

Note that in the present disclosure, “images” include both moving images and still images. It is assumed, for example, that the imaging devices 10 mainly capture moving images, but images displayed on the terminal devices 5 might be moving images or still images.

In addition, the “images” refer to images actually displayed on a screen, but the “images” in a signal processing process or a transmission path until being displayed on the screen refer to image data.

EPTS data generated on the basis of images captured by the imaging devices 10 is transmitted to the server device 2. In a case where an information processing device (not illustrated) that records images captured by the plurality of imaging devices 10 and that generates EPTS data is provided for a stadium, for example, the EPTS data generated by the information processing device is transmitted to the server device 2.

Alternatively, captured images obtained by the imaging devices 10 may be transmitted to the server device 2, and the server device 2 may generate EPTS data.

The sensors 4 are sensors that detect motions of players or the like. More specifically, the sensors 4 are assumed to be sensors attached to the players and a ball, such as the acceleration sensors and the GPS sensors described above. Information regarding the motions of the players can also be obtained from information detected by the sensors 4. Alternatively, the information from the sensors 4 can be used as supplementary information in a case where skeleton capture data is obtained from images or postures or the like are estimated.

The information detected by the sensors 4 may be transmitted to the server device 2, or may be input to the information processing device (not illustrated) that is provided for the stadium and that generates EPTS data.

The weather measurement device 3 measures temperature and humidity at a location of the subjects, that is, the soccer stadium in this example. Weather, rainfall, snowfall, wind speed, sunshine conditions, and the like may also be measured.

The weather measurement device 3 measures such weather information regarding the stadium and transmits the weather information to the server device 2. The transmission may be performed once at a start of a match, for example, or may be sequentially performed at intervals of 3 to 5 minutes, for example, during a match.

The terminal devices 6 are assumed to be, for example, terminal devices owned by the players including smartphones, tablet terminals, and personal computers. For example, the terminal devices 6 are smartphones or the like owned by the individual players of a team that operates the information analysis system 1.

Each player inputs condition information using the terminal device 6, for example, before a match. Although a specific example of the condition information will be described later, the condition information is, for example, information that affects a physical condition of each player, such as sleep time and wake-up time.

The terminal devices 5 are also information processing devices including smartphones, tablet terminals, and personal computers, for example, but the terminal devices 5 are assumed to be devices used by persons related to the team such as coaches and staff members. In addition, the terminal device 5 are devices that present various pieces of analysis information, such as exercise loads and playing conditions of the individual players to the coaches or the like, for example, during a match or the like.

The server device 2 performs various types of processing for providing analysis information for the terminal devices 5. For example, the server device 2 performs processing of calculating values of exercise loads of the subjects on the basis of skeleton capture data regarding the subjects generated from images captured by the imaging devices 10. The server device 2 then performs various types of processing for causing the terminal devices 5 to present the values of the exercise loads.

As the server device 2, an information processing device that performs cloud computing, that is, a cloud server, is assumed.

The processing for providing analysis information for the terminal devices 5, however, may be performed by an information processing device other than the cloud server, instead. It is conceivable, for example, that an information processing device provided for a match venue, such as a personal computer, has a function as the server device 2 and performs the processing of calculating the values of the exercise loads of the players, who are the subjects, and the processing of causing the terminal devices 5 to present the values of the exercise loads.

Furthermore, it is also conceivable that the terminal devices 5 also have a function as the server device 2 and perform the processing of calculating the values of the exercise loads of the players, who are the subjects, and the processing of displaying the values of the exercise loads.

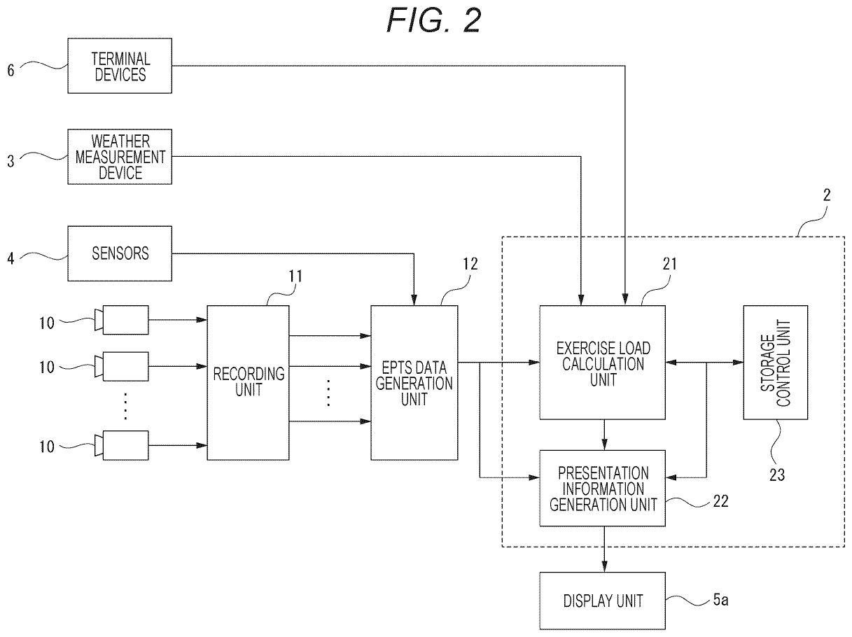

FIG. 2 illustrates an example of a functional configuration of the server device 2 and an input/output system relating to the server device 2 in the information analysis system 1 illustrated in FIG. 1 referred to above.

The plurality of imaging devices 10 is implemented as, for example, digital camera devices including imaging elements such as charge-coupled device (CCD) sensors or complementary metal-oxide-semiconductor (CMOS) sensors, and obtains captured images as digital data. In this example, each imaging device 10 obtains a captured image as a moving image.

As described with reference to FIG. 1, each imaging device 10 captures an image of how a competition such as soccer, basketball, baseball, golf, or tennis is being held, and is arranged at a predetermined position in a competition site where the competition is held. The number of imaging devices 10 is one or more and is not particularly specified, but it is advantageous for the purpose of generating accurate EPTS data that the number is as large as possible.

Each imaging device 10 captures a moving image in synchronization with the other imaging devices 10 and outputs the captured image.

A recording unit 11 records each of the images captured by the plurality of imaging devices 10 and supplies the captured image to an EPTS data generation unit 12.

The EPTS data generation unit 12 performs analysis processing on one or a plurality of captured images, generates EPTS data individually, and then generates overall EPTS data by integrating together the individual EPTS data. The EPTS data includes, for example, positions of the players and the ball at each frame timing, skeleton capture data regarding the players, postures of the players based on the skeleton capture data, information regarding a rotation speed and a rotation direction of the ball, and the like.

The EPTS data generation unit 12 may also generate EPTS data using not only captured images but also information obtained by the sensors 4, that is, for example, information from the acceleration sensor embedded in the ball and the GPS sensors attached to uniforms of the players.

The EPTS data generation unit 12 can generate, as EPTS data regarding an entire match, for example, information with which the positions and the postures of all the players participating in the match at each time point, the position and a condition of the ball at each time point, and the like can be determined.

The EPTS data generation unit 12 can generate EPTS data from a plurality of captured images obtained by the plurality of imaging devices 10 and can also generate

EPTS data from a plurality of captured images obtained by one of the imaging devices 10. Furthermore, the EPTS data generation unit 12 can generate EPTS data from a plurality of images and information from one or a plurality of sensors and can also generate EPTS data from one captured image and information from one of the sensors.

The EPTS data generated by the EPTS data generation unit 12 is transmitted to the server device 2.

Note that the EPTS data generation unit 12 may be provided in the server device 2. In this case, for example, images captured by the imaging devices 10 and information detected by the sensors 4 may be transmitted to the EPTS data generation unit 12 in the server device 2 via network communication or the like.

In addition, as described with reference to FIG. 1, the terminal devices 6 upload, to the server device 2, the condition information from the players.

In addition, the weather information obtained by the weather measurement device 3 is sequentially uploaded, for example, to the server device 2.

The server device 2 is implemented as an information processing device such as a computer device and is provided, by software, for example, with functions as an exercise load calculation unit 21, a presentation information generation unit 22, and a storage control unit 23.

The exercise load calculation unit 21 performs the processing of calculating the values of the exercise loads of the players on the basis of, for example, EPTS data including skeleton capture data regarding the players generated from captured images. During a soccer match, for example, the exercise load calculation unit 21 calculates, on the basis of skeleton capture data, a value of an exercise load for each of 11 players of an own team participating in the match. The own team refers to a team that operates the information analysis system 1.

The exercise load calculation unit 21 can also calculate, on the basis of skeleton capture data, a value of an exercise load for each of 11 players of an opposing team participating in the match. Since skeleton capture data is obtained from captured images, a value of an exercise load of a player can be calculated regardless of whether the player belongs to the own team or the opposing team, insofar as an image of the player is obtained.

Note that when calculating the exercise load, the exercise load calculation unit 21 might refer to the condition information regarding each of the players of the own team transmitted from the terminal devices 5 or might refer to the weather information transmitted from the weather measurement device 3.

The storage control unit 23 performs processing of storing the values of the exercise loads of the subjects sequentially calculated by the exercise load calculation unit 21 in a storage medium. For example, the exercise load calculation unit 21 obtains a value of an exercise load in a most recent period and a value of a cumulative exercise load from a start of a match for each player at predetermined time intervals, and the storage control unit 23 stores these values together with a time.

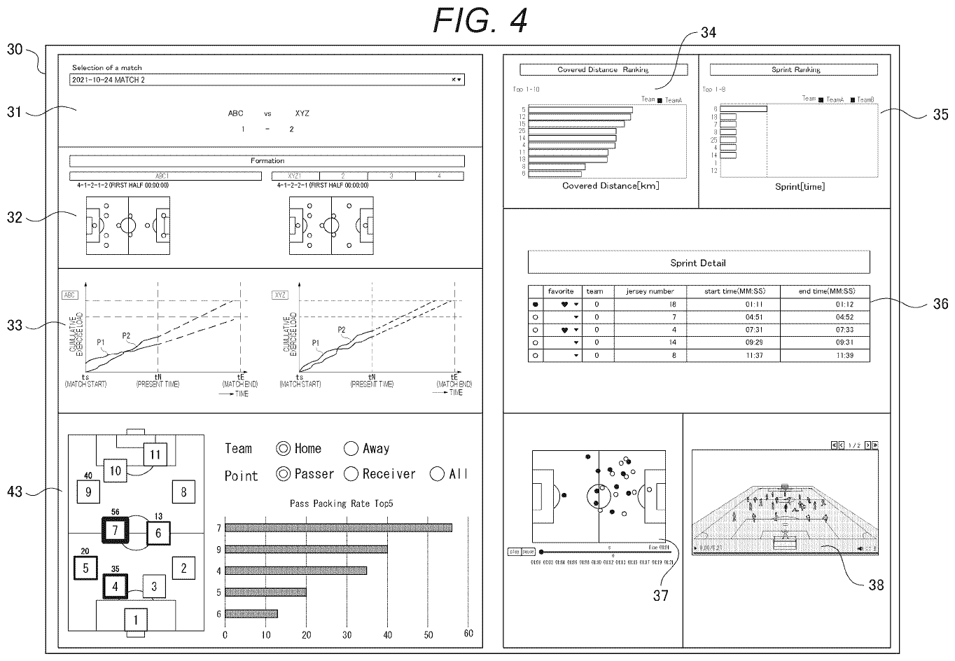

The presentation information generation unit 22 performs processing of generating presentation information that reflects the values of the exercise loads of the subjects calculated by the exercise load calculation unit 21. For example, the presentation information generation unit 22 generates information for displaying the exercise loads as exercise load information 33 in an analysis dashboard 30 (refer to FIG. 4), which will be described later.

The information for display may be specifically image data itself to be displayed, or data, parameters, or the like for generating a graph image and the like. For example, the presentation information generation unit 22 generates the value of the cumulative exercise load of each player at each time from a start of a match as information for displaying a graph image.

It is assumed in the embodiment that the presentation information generation unit 22 generates, for example, information for causing the terminal devices 5 to display the analysis dashboard 30. That is, the presentation information generation unit 22 generates information for display based on a result of calculation performed by the exercise load calculation unit 21 as the exercise load information 33 in the analysis dashboard 30.

Note that although various types of information are displayed in the analysis dashboard 30 in addition to the exercise load information 33, it is assumed that the presentation information generation unit 22 generates information for presenting the various types of information on the basis of an image analysis of captured images, EPTS data, match progress information received from a data center, which is not illustrated, or the like.

The exercise load calculation unit 21, the presentation information generation unit 22, and the storage control unit 23 described above may be provided in one information processing device, but may be provided separately in a plurality of information processing devices, instead.

An image, or data for generating an image, generated by the presentation information generation unit 22 in the server device 2 is transmitted to and displayed on display units 5a. The display units 5a are display units of the terminal devices 5.

For example, various types of analysis information are displayed in the form of the analysis dashboard 30 illustrated in FIG. 4.

Configuration of an information processing device 70 used in the information analysis system 1 described above with reference to FIGS. 1 and 2 will be described.

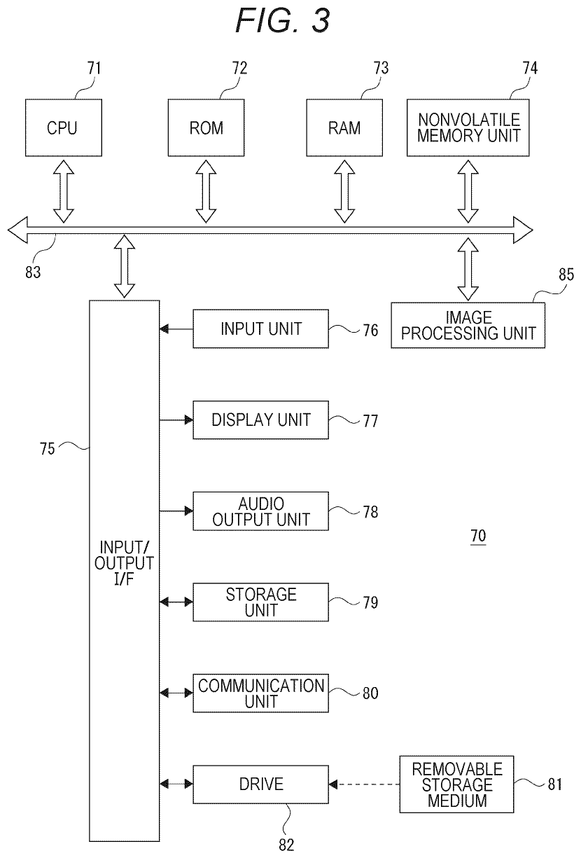

For example, the server device 2, the terminal devices 5 and 6, the EPTS data generation unit 12 in FIG. 2, and the like can be achieved by the information processing device 70 illustrated in FIG. 3.

Furthermore, the information processing device 70 may be implemented as, for example, a dedicated workstation, a general-purpose personal computer, a mobile terminal device, or the like.

A CPU 71 of the information processing device 70 illustrated in FIG. 3 performs various types of processing in accordance with a program stored in a ROM 72 or a nonvolatile memory unit 74 such as an electrically erasable programmable read-only memory (EEP-ROM), for example, or a program loaded from a storage unit 79 into a RAM 73. The RAM 73 also stores, as appropriate, data and the like necessary for the CPU 71 to perform the various types of processing.

An image processing unit 85 is implemented as a processor that performs various types of image processing. For example, the image processing unit 85 is a processor capable of performing any of image generation processing, image analysis processing on captured images or the like, generation processing of animation images or 3D images, data base (DB) processing, image effect processing, EPTS data generation processing, and the like.

The image processing unit 85 can be achieved by, for example, a CPU separate from the CPU 71, a graphics processing unit (GPU), general-purpose computing on graphics processing units (GPGPU), an artificial intelligence (AI) processor, or the like.

Note that the image processing unit 85 may be provided as a function in the CPU 71.

The CPU 71, the ROM 72, the RAM 73, the nonvolatile memory unit 74, and the image processing unit 85 are connected to one another via a bus 83. An input/output interface 75 is also connected to the bus 83.

An input unit 76 including an operation element or an operation device is connected to the input/output interface 75. As the input unit 76, for example, one of various operation elements and operation devices including a keyboard, a mouse, a key, a dial, a touch panel, a touchpad, a remote controller, and the like is assumed.

The input unit 76 detects a user operation, and the CPU 71 interprets a signal corresponding to the input operation.

In addition, a display unit 77 including a liquid crystal display (LCD), an organic electro-luminescence (EL) panel, or the like and an audio output unit 78 including a speaker or the like are integrally or separately connected to the input/output interface 75.

The display unit 77 displays various pieces of information as a user interface. The display unit 77 is implemented as, for example, a display device provided in a housing of the information processing device 70, a separate display device connected to the information processing device 70, or the like.

The display unit 77 displays various images on a display screen on the basis of an instruction from the CPU 71. In addition, the display unit 77 displays various operation menus, icons, messages, and the like, that is, graphical user interfaces (GUIs), on the basis of an instruction from the CPU 71.

In a case where the information processing device 70 is regarded as a terminal device 5, for example, the display unit 77 displays the analysis dashboard 30 illustrated in FIG. 4.

In some cases, a storage unit 79 including a solid-state drive (SSD), a hard disk drive (HDD), or the like and a communication unit 80 including a modem or the like are connected to the input/output interface 75.

In a case where the information processing device 70 is regarded as the server device 2, for example, the storage unit 79 can be regarded as the storage medium used by the storage control unit 23 to store information.

The communication unit 80 performs communication processing via a transmission path such as the Internet, and performs wired/wireless communication with various devices and communication based on bus communication or the like.

A drive 82 is also connected to the input/output interface 75 as necessary, and a removable storage medium 81 such as a flash memory, a memory card, a magnetic disk, an optical disc, or a magneto-optical disk is attached to the drive 82 as appropriate.

With the drive 82, data files such as image files, various computer programs, and the like can be read from the removable storage medium 81. The read data files are stored in the storage unit 79, and the display unit 77 and the audio output unit 78 output images and sounds included in the data files. In addition, the computer programs and the like read from the removable storage medium 81 are installed in the storage unit 79 as necessary.

With the information processing device 70, software can be installed through network communication by the communication unit 80 or the removable storage medium 81. Alternatively, the software may be stored in the ROM 72, the storage unit 79, or the like in advance.

### 2. Example of how Analysis Dashboard is Displayed

FIG. 4 illustrates an example of the analysis dashboard 30 displayed on the terminal devices 5. For example, the coaches and the like of the team that operates the information analysis system 1 can check states, conditions, and achievements of the players, a situation of a match, and the like with the analysis dashboard 30 during the match or practice.

Various pieces of information are presented in the analysis dashboard 30. For example, FIG. 4 illustrates an example in which match score information 31, formation information 32, the exercise load information 33, a covered distance ranking 34, a sprint ranking 35, sprint information 36, an overhead animation 37, a real image 38, and packing points 43 are displayed.

The match score information 31 indicates a score status of a current match.

The formation information 32 indicates current formation of the own team and the opposing team.

As the exercise load information 33, cumulative exercise loads of the players of the own team and the opposing team are displayed. Details will be described later.

In the covered distance ranking 34, covered distances of the players are shown in descending order.

In the sprint ranking 35, the number of sprints of the individual players is shown in descending order.

As the sprint information 36, a player, a start time, an end time, and the like are shown for each sprint observed during the match. Note that not all sprints during a match need to be displayed. For example, an appropriate threshold in extraction of sprints might vary depending on a player (professional, youth, and junior generations, etc.) to be analyzed. In consideration of such a possibility, sprints to be displayed may be dynamically switched on the basis of extraction conditions (display conditions) specified by a user operation. For example, a user may input the sprint extraction conditions using a drop-down list function on a UI of the terminal device 5, and only data regarding sprints that satisfy the input extraction conditions may be displayed. As the sprint extraction condition, for example, the user may input threshold values of covered distance and duration, namely, for example, “24 km/h or faster for 1 second or longer”.

As the overhead animation 37, motions of the players of both teams during the match are displayed as an animation image.

As the real image 38, an actually captured image is displayed.

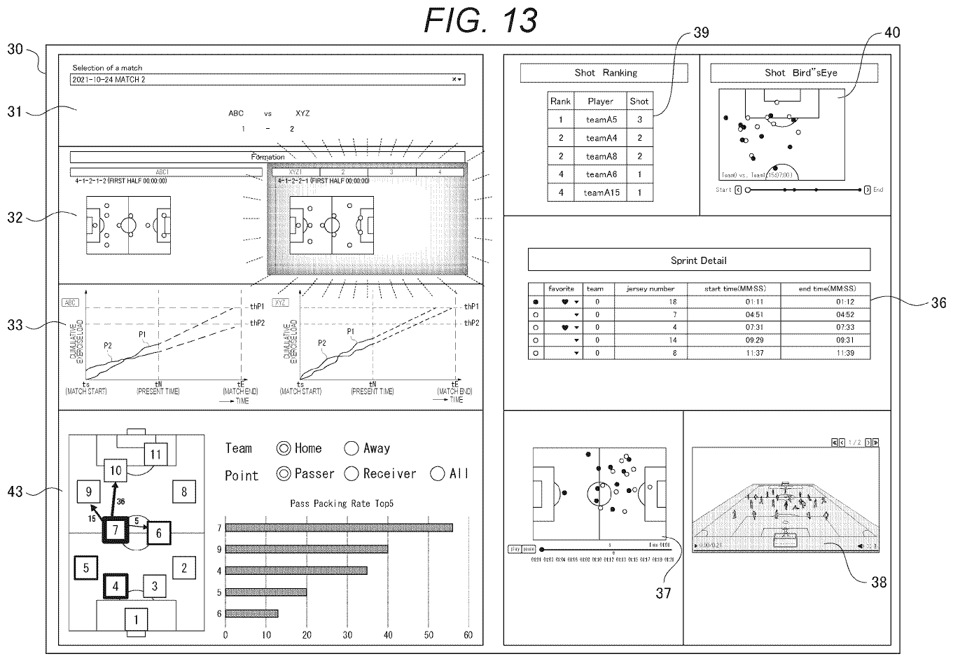

As the packing points 43, points (left figure) of each player and a graph (right figure) of a ranking of points are displayed. The packing points are numerical values indicating the number of times that a team possessing the ball has gone past (overtaken) an opposing player in a forward direction through dribbling or passing in a soccer match or the like. For example, if a player has overtaken one opposing player in the forward direction through dribbling or passing, one point is given, and if a player has overtaken two opposing players, two points are given. Note that the same points are given to both a player who has passed the ball and a player who has received the pass. Packing points in the match are accumulated for each player and displayed near an icon of the player. Values in squares in the figure are uniform numbers, and bold values above (displayed in red, for example, in practice) are cumulative packing points. For example, the cumulative packing points of a player with uniform number 7 is “56”. By clicking an icon of a player, a breakdown of the packing points can be displayed. FIG. 13 illustrates, for example, a case where an icon of the player with uniform number 7 is clicked. An example in the figure indicates, using an arrow, that the player with uniform number 7 has earned cumulative packing points “36” against a player with uniform number 10. As the points increase, the arrow is displayed thicker. As a result, it is possible to visualize which player's pass to which player has been more effective.

Each of the pieces of presentation information described above is an example, and various pieces of information such as a ranking of the number of shoots, overhead views at times of shooting, and acceleration information regarding the players can also be displayed in addition to these.

For example, the analysis dashboard 30 may display various pieces of information over a plurality of pages, or may display various pieces of information as a result of scrolling.

These pieces of information displayed in the analysis dashboard 30 may be fixed or customized by the user. In the case of a display method in which page transition or scrolling is performed, for example, it is preferable to be able to configure a top page such that images of information frequently referred to by the user are arranged.

The display content of the analysis dashboard 30 is, as described above, based on information for display generated by the presentation information generation unit 22 of the server device 2.

As for the display content of the exercise load calculation unit 21, the presentation information generation unit 22 generates information for display using a result of calculation performed by the exercise load calculation unit 21.

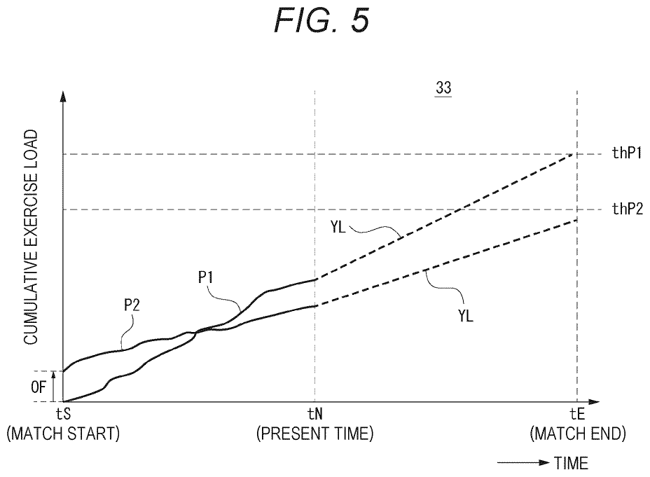

FIG. 5 illustrates a display example of the exercise load information 33.

The figure illustrates exercise loads of two players P1 and P2 for the sake of description. In a case where, for example, the players of the own team and the opposing team are displayed as in FIG. 4, however, it is conceivable to display the 11 players of the own team and the 11 players of the opposing team in a graph as in FIG. 5. Alternatively, an exercise load of a player selected by the user may be displayed in a graph.

In the exercise load information 33 of FIG. 5, a vertical axis represents the cumulative exercise load, and a horizontal axis represents time from a match start time tS to a match end time tE.

In this example, the cumulative exercise load from the match start time tS to a present time tN is shown for each of the players P1 and P2. The cumulative exercise load is updated in real time. Note that it is preferable in practice to improve visibility by displaying lines (cumulative exercise load lines) indicating transition of the cumulative exercise load in different colors for different players.

The cumulative exercise load line of each of the players P1 and P2 indicates how the value of the exercise load, which is obtained on the basis of the amount of exercise, an exercise mode, and the like in a unit period during the match, has been accumulated since the match start time tS. A slope of the cumulative exercise load line of each player at each time point, therefore, varies depending on how the player has played in unit time during the match. For example, the slope becomes steep immediately after a sprint.

In addition, in this example, an offset OF is set for the cumulative exercise load of the player P2 at the match start time tS. That is, it is assumed that there is already a certain exercise load at the start of the match. This is set in accordance with condition information regarding a player and the like. In a case where there is condition information indicating that the player P2 has appeared full time in a match two days ago, for example, it is determined that the player P2 has not been fully recovered, and the offset OF is set for the exercise load. By customizing an offset of the exercise load of each player in accordance with a condition of the player like this, the exercise load information 33 that takes into account the condition of the player is presented.

In addition, between the present time tN and the match end time tE, predicted values of the cumulative exercise load of each player are shown. For example, the transition of the cumulative exercise load from the start of the match to the end of the match is predicted on the basis of a tendency from the start of the match, and a prediction line YL is displayed. Although the prediction lines YL are indicated by broken lines in the figure, the prediction lines YL are indicated using a color, a line type, or the like different from that used for the cumulative exercise load lines up to the present time tN to clearly indicate that the prediction lines YL are based on predicted values.

Furthermore, high-load lines thP1 and thP2, which is used to determine a high-load state, are displayed for the corresponding players. The high-load line thP1 is a value for determining that the player P1 is in the high-load state, and the high-load line thP2 is a value for determining that the player P2 is in the high-load state. For example, a high-load line for each player is set and displayed on the basis of comparison with past match data. It is conceivable, for example, to determine the high-load lines thP1 and thP2 as maximum values of load performance of the corresponding players in past matches, average values of samples of top several percent of the load performance, or the like.

It is desirable to set the high-load line for each player since a limit of the exercise load below which play performance does not deteriorate is different for each player. A high-load line common to all players, however, may be set as a general estimate, instead.

The cumulative exercise loads of the players measured, predicted, and displayed in real time during a match like this can be used by the own team as information for changing players. In a case where a cumulative exercise load of a certain player approaches a high-load line, for example, a coach can consider changing players. The coach can also make a plan for a change of players by on the basis of prediction lines YL.

It is also possible to consider a change in strategy or formation in consideration of the cumulative exercise load of each player.

By also displaying cumulative exercise loads of the players of the opposing team, the cumulative exercise loads can be used as information for a game strategy. It is possible, for example, to determine to mark a player with a small cumulative exercise load (a forward (FW) or a midfielder (MF) in soccer) or to make an attack from a side of a player with a large cumulative exercise load among defenders of the opposing team.

Note that, in FIG. 5, the high-load line for the cumulative exercise load of each player is represented as an absolute value, but the cumulative exercise load may be normalized with the high-load line of each player as 100% and displayed as a relative value.

<3. Calculation and Display of Exercise Load>

In order to achieve the display described above, the server device 2 performs processing of calculating a value of an exercise load of each player using the function of the exercise load calculation unit 21. In the present embodiment, the exercise load is estimated from motions of each player, a weather condition, and a condition of the player.

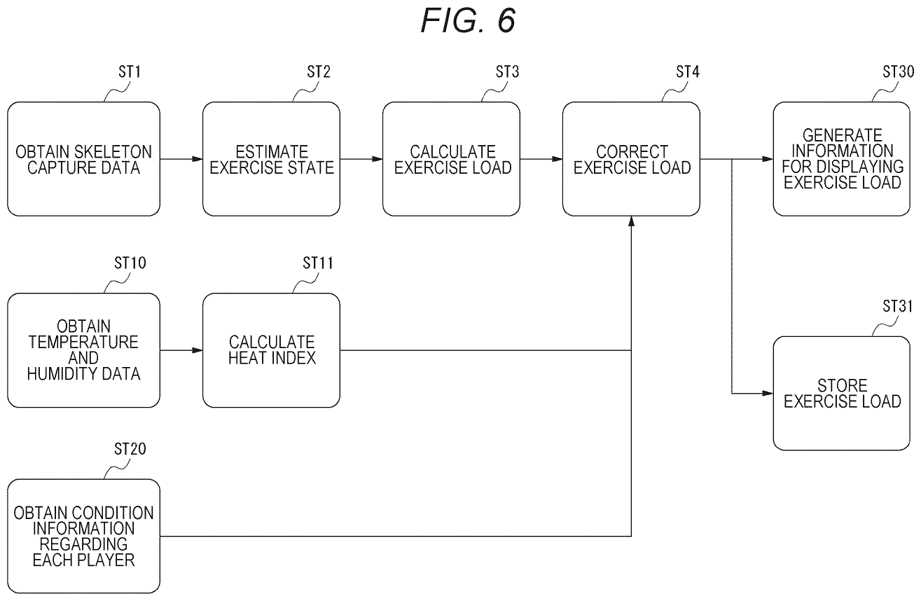

FIG. 6 illustrates an outline of processing performed by the server device 2 regarding calculation and display of an exercise load.

### Step ST1: Obtain Skeleton Capture Data

The exercise load calculation unit 21 of the server device 2 continuously obtains, for example, skeleton capture data (EPTS data) regarding each player at each frame timing or each intermittent frame timing of a captured image during a match.

### Step ST2: Estimate an Exercise State

The exercise load calculation unit 21 estimates an exercise mode of each player on the basis of the skeleton capture data. More specifically, first, each of indirect positions of the player's body is determined from the skeleton capture data. By observing changes in the indirect positions in a period of a plurality of frames, it is possible to estimate an exercise mode of the player. A specific exercise mode based on a running speed, a jumping motion, and a contact condition, for example, can be estimated from such skeleton capture data.

As the exercise mode, a stopped state, a slow running state, a fast running state, a sprint state, or the like can be estimated on the basis of the running speed. In addition, a heading state or a goalkeeper's motion can be estimated on the basis of the jumping motion. A contact, a collision, a state of falling down due to a foul, or the like can be estimated on the basis of the contact condition in relation to another player.

### Step ST3: Calculate an Exercise Load

The exercise load calculation unit 21 calculates a value of an exercise load using the estimated exercise mode. It is conceivable that this processing is performed for each player, for example, at predetermined time intervals. In order to ensure improved real-time performance, for example, the processing may be performed at shorter time intervals such as 5 second intervals or 10 second intervals with 5 seconds or 10 seconds as a unit period. Alternatively, if a requirement for real-time performance is not very high, the processing may be performed in a longer span such as at intervals of 30 seconds or at intervals of 1 minute.

The exercise load is calculated on the basis of, for example, metabolic equivalents (METs). As known, METs are reference values for the amount of physical activity, the amount of exercise, and physical strength. It is an index indicating, with a relative value, energy consumed in various activities with a resting state as “1 MET”. The value of the exercise load of the player in a current unit period, therefore, can be obtained from a METs value of an estimated exercise mode and duration of the exercise mode.

### Step ST10: Obtain Temperature and Humidity Data

The exercise load calculation unit 21 obtains temperature and humidity information in a current match venue as weather information from the weather measurement device 3. As described above, in a case where the weather information is transmitted at intervals of 5 minutes, for example, the exercise load calculation unit 21 may obtain latest temperature and humidity information. Information regarding temperature and humidity at a time as close as possible to the processing in step ST4, which will be described later, is obtained. Note that not only temperature and humidity but also rainfall in the case of rainy weather, wind speed, and the like may be obtained.

### Step ST11: Calculate a Heat Index

The exercise load calculation unit 21 calculates a heat index by using the weather information (information regarding temperature and relative humidity) obtained from the weather measurement device 3. The higher the relative humidity and temperature, the higher the heat index. Note that if information such as global solar radiation and an average wind speed can be obtained from the weather measurement device 3, the heat index is calculated in consideration of these. The more the global solar radiation, the higher the heat index, and the lower the average wind speed, the higher the heat index.

### Step ST20: Obtain Condition Information Regarding Each Player

Condition information input by each player from the terminal device 6 before the match is obtained. This condition information is referred to in processing in step ST4 described later.

Examples of the condition information include the following.
Practical time, a covered distance, and an exercise load from a predetermined number of days before the match to a day of the match (past one week, past three days, etc.)
Sleep time.

Body temperature at wake-up and a start of the match.
A heart rate at wake-up or the start of the match
A temperature difference from a previous day
Atmospheric pressure (bad health due to low atmospheric pressure)
Time elapsed since a previous meal
Time elapsed since a most recent injury
Time elapsed since a previous match
Play cumulative time in the previous match

The above is an example, and other items may be included.

These pieces of information are obtained before the start of the match, but may include a psychological condition during the match. It is also conceivable, for example, that the psychological condition changes depending on whether the team is winning or losing, and this in turn affects the exercise load. Progress of the match (winning or losing and a score difference), therefore, may be used as the condition information.

### Step ST4: Correct the Exercise Load

The exercise load of each player calculated in step ST3 is corrected. The calculated exercise load is an exercise load in unit time according to the estimated exercise mode, but the weather and the condition of the player also affect the exercise load in practice. The calculated exercise load, therefore, is corrected using a correction coefficient based on the heat index. In a case where the heat index is high, for example, the value of the exercise load is increased. In addition, the correction may be performed in accordance with wind speed, rainfall, snowfall, and the like, and the correction may be performed such that the higher the wind speed, the higher the exercise load, and the larger the rainfall and the snowfall, the higher the exercise load.

In addition, the correction coefficient is set on the basis of the condition information regarding each player, and correction calculation is performed. As a result, an exercise load according to the condition of the player is obtained. In a case where information regarding sleep time is obtained as the condition information regarding the player and the obtained sleep time is longer than the longest time or shorter than the shortest time of reference sleep time, for example, the exercise load becomes higher through the correction than in a case where the obtained sleep time is within the reference sleep time. In addition, in a case where information regarding time elapsed since a previous match is obtained as the condition information regarding the player and the obtained elapsed time is longer than the longest time or shorter than the shortest time of reference elapsed time, for example, the exercise load becomes higher through the correction than in a case where the obtained elapsed time is within the reference elapsed time.

The correction of the value of the exercise load in this manner means that the weather information and the condition information are reflected in the slope of the cumulative exercise load line in the exercise load information 33.

Note that it is assumed that the condition information can be obtained for only the players of the own team. It is therefore conceivable that the values of the exercise loads of the players of the opposing team cannot be corrected on the basis of the condition information, and can only be corrected on the basis of the weather information.

### Step ST31: Store the Exercise Load

The storage control unit 23 stores, in the storage medium, the value of the exercise load of each player obtained by the exercise load calculation unit 21 in the processing up to step ST4. For example, the calculated value of the exercise load is stored for each player together with information indicating the number of unit times from the start of the match.

### Step ST30: Generate Information for Displaying the Exercise Load

The presentation information generation unit 22 generates information for displaying the exercise load information 33 illustrated in FIG. 5 on the basis of the exercise load of each player obtained by the exercise load calculation unit 21 in the processing up to step ST4. An image itself or information necessary for the terminal device 5 to display the image is generated.

In the case of the example in FIG. 5, for example, the presentation information generation unit 22 obtains, in order to present the cumulative exercise load of each player at each time point, the value of the cumulative exercise load per unit time and uses the value as the information for display. The cumulative exercise load per unit time from the match start time tS can be obtained by cumulatively adding the exercise load stored by the storage control unit 23 for each unit time.

Note that at a stage after the correction in step ST4, the exercise load calculation unit 21 may calculate the cumulative exercise load, and the storage control unit 23 may store the cumulative exercise load in the storage medium. In this case, the presentation information generation unit 22 can generate the information for display by reading the value of the cumulative exercise load per unit time from the storage medium.

Depending on the server device 2, the value of the exercise load of each player is obtained through the above-described procedure in FIG. 6, and the exercise load information 33 can be displayed on the terminal device 5 in the analysis dashboard 30.

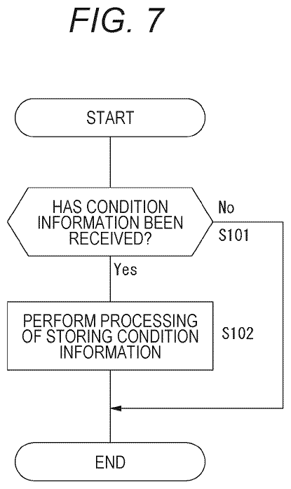

FIGS. 7 to 10 illustrate specific examples of processing for achieving the procedure in FIG. 6. FIGS. 7 to 10 illustrate examples of processing performed by the CPU 71 of the information processing device 70, which functions as the server device 2, on the basis of a program. This program is a program for executing processing functions as the exercise load calculation unit 21, the presentation information generation unit 22, and the storage control unit 23.

FIG. 7 illustrates processing of obtaining condition information before a match.

The CPU 71 of the server device 2 monitors, in step S101, reception of condition information and, upon receiving condition information, performs, in step S102, processing of storing the condition information.

It is assumed, for example, that each player of the own team uploads his/her condition information from the terminal device 6 to the server device 2 before the match. An input screen of various items described as the above condition information is provided for each player using application software to request the player to make inputs. Each player makes inputs and uploads the inputs using the terminal device 6 at any time before the match. The processing in FIG. 7 corresponds to such an action, and the CPU 71 monitors the condition information sequentially transmitted from the individual players, and performs processing of storing the condition information in association with the players in accordance with the reception.

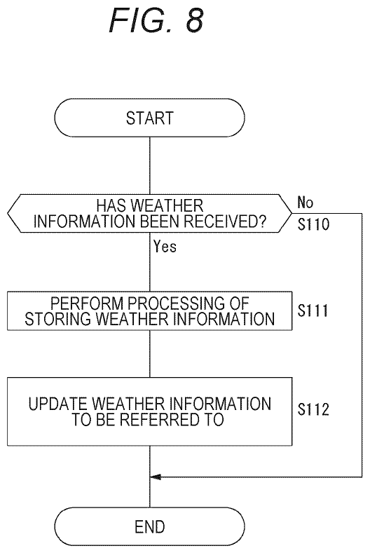

FIG. 8 illustrates processing of receiving weather information from the weather measurement device 3 before or during a match.

The CPU 71 of the server device 2 monitors reception of weather information in step S110. Upon receiving weather information, the CPU 71 performs processing of storing the weather information in step S111. For example, the weather information is stored in association with time.

In step S112, the CPU 71 updates the weather information to be referred to in the correction processing in step ST4 in FIG. 6. For example, the CPU 71 updates the heat index and the information regarding rainfall and snowfall in accordance with latest weather information.

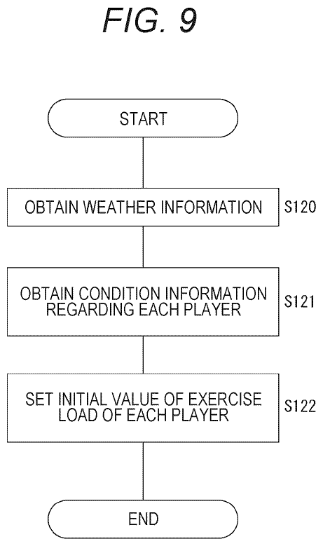

FIG. 9 is processing of setting the offset OF for each player, which is performed before a start of a match.

The CPU 71 of the server device 2 obtains weather information in step S120. For example, latest weather information stored in the processing in FIG. 8 is obtained.

In step S121, the CPU 71 obtains the condition information regarding each player stored in the processing in FIG. 7 before the current match.

In step S122, the CPU 71 sets an initial value of the exercise load of each player. That is, a value of the offset OF illustrated in FIG. 5 is set for each player. For example, the CPU 71 sets the offset OF for a player determined, on the basis of condition information, to be fatigued or not in perfect physical condition in accordance with severity of the condition. For example, the offset OF is set to be larger as the amount of practice from a predetermined number of days before the match to a day of the match becomes larger, the covered distance is longer, and the exercise load is higher. In addition, in a case where the heat index or the weather condition is bad, it is also conceivable that the CPU 71 sets the offset OF in accordance with the weather or the like for every player. For example, the higher the heat index is, the larger the offset OF is set.

Note that the offset OF may be set on the basis of only the condition information or may be set on the basis of only the weather information.

Alternatively, it is also conceivable not to set the offset OF. In a case where the condition information and the weather information are reflected in the correction processing in step ST4 in FIG. 6, for example, a load corresponding to the offset OF may be applied. That is, the weather information and the condition information may be reflected only on the slope of the cumulative exercise load line (the amount of increase in the cumulative exercise load) in FIG. 5.

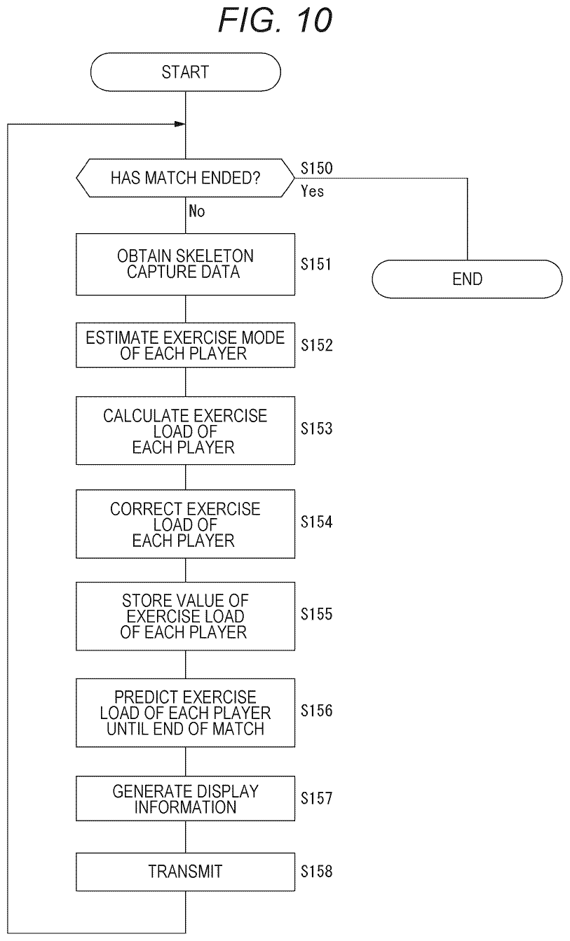

FIG. 10 illustrates processing of transmitting information for calculating and displaying an exercise load during a match.

The CPU 71 of the server device 2 starts the processing in FIG. 10 as a match starts.

In step S150, the CPU 71 determines whether the match has ended, and repeats processing in steps S151 to S158 until the end of the match.

Note that, since there is a break such as halftime in practice, step S150 includes not only the determination as to the end of the match but also a determination as to an end in the middle of the match, that is, for example, an end of a first half.

In addition, the processing in FIG. 10 starts again when a second half starts, but at the start of the second half, the cumulative exercise load may be corrected in consideration of restoration of the player's physical strength in the halftime.

During the match, the CPU 71 obtains skeleton capture data in step S151.

In step S152, the CPU 71 estimates an exercise mode of each player.

In step S153, the CPU 71 sets a value of an exercise load of each player in unit time.

In step S154, the CPU 71 corrects the value of the exercise load calculated for each player in accordance with the weather information and the condition information.

In step S155, the CPU 71 stores the value of the exercise load calculated for each player in the storage medium.

The above is the processing described as steps ST1, ST2, ST3, ST4, and ST 31 in FIG. 6.

In step S156, the CPU 71 performs processing of predicting the exercise load of each player until the end of the match.

That is, as illustrated in FIG. 5, prediction information regarding the cumulative exercise load of each player from the present time tN to the match end time tE is generated as the exercise load information 33 in order to display the prediction information regarding the cumulative exercise load of each player.

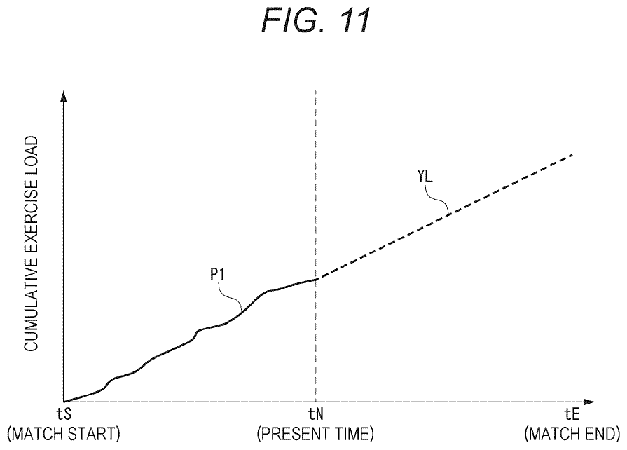

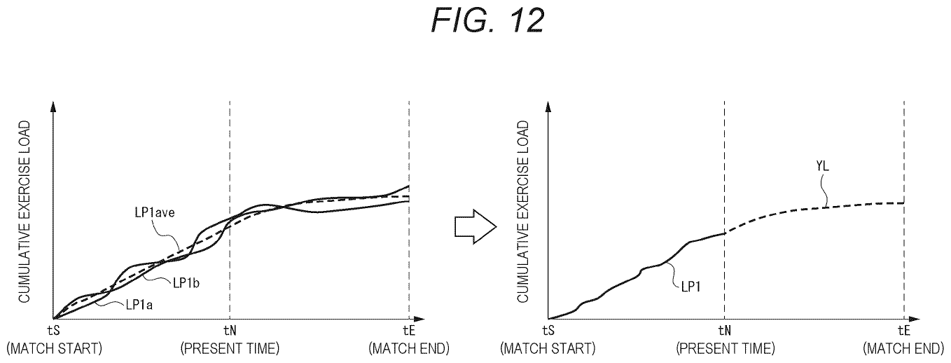

FIGS. 11 and 12 illustrate examples of a method of the prediction processing.

FIG. 11 illustrates a method of generating, for each player, a prediction line YL of a cumulative exercise load after the present time tN on the basis of a slope of a curve of the cumulative exercise load from the match start time tS to the present time tN.

That is, since the slope is obtained from the cumulative exercise load up to the present time tN, a line extended at the slope from the present time tN is set as the prediction line YL. As a result, it is possible to present the prediction line YL according to physical strength of the individual player, a role (position) of the player in a competition, and the like.

The example in FIG. 11 is an example in which a future exercise load is linearly predicted.

FIG. 12 illustrates a method for generating, for each player, the prediction line YL of the cumulative exercise load after the present time tN on the basis of average values in past matches.

A left diagram in FIG. 12 illustrates a cumulative exercise load line LP1a in a past match a and a cumulative exercise load line LP1b of a match b for the player P1. Although the diagram illustrates only two matches, an average cumulative exercise load line LP1ave of the player P1 may be obtained with reference to cumulative exercise load lines from more matches in practice. The average cumulative exercise load line LP1ave is then applied after the present time tN to obtain the prediction line YL. As a result, it is possible to present the prediction line YL according to an actual exercise load of the individual player. The example in FIG. 12 is an example in which a future exercise load is nonlinearly predicted.

In step S157 in FIG. 10, the CPU 71 generates information for display. That is, the processing is processing described as step ST30 in FIG. 6.

In step S158, the CPU 71 performs processing of transmitting the generated information for display to the terminal device 5.

Note that although the above description has been given from a viewpoint of the processing for displaying the exercise load information 33, the CPU 71 of the server device 2 generates, in practice, information for displaying various pieces of information constituting the analysis dashboard 30 in accordance with, for example, an image analysis result and EPTS data using the function of the presentation information generation unit 22. In steps S157 and S158, therefore, not only the information for displaying the exercise load information 33 but also information for displaying other pieces of information are generated and sequentially transmitted to the terminal device 5.

By repeating the above processing from steps S151 to S158, the exercise load information 33 is sequentially updated and displayed on the terminal device 5 in the analysis dashboard 30. As a result, a coach can grasp a state of the player in real time.

### 4. Example of How Display of Analysis Dashboard is Controlled

Next, an example of processing relating to how to control display of the analysis dashboard 30 will be described.

As described with reference to FIG. 4, various contents are displayed in the analysis dashboard 30. Such contents include, for example, the match score information 31, the formation information 32, the exercise load information 33, and the like.

Information to be focused on among these contents differs depending on the user. Depending on his/her thoughts and strategies, a coach frequently checks some pieces of information and does not pay much attention to other pieces of information.

It is therefore preferable that arrangement of information contents be customizable for each user. Furthermore, processing of preferentially disposing information on which the user frequently places a cursor or information on which the user places the cursor for a long time at a top of a page or the like may be automatically performed.

FIG. 13 illustrates an example in which a shot ranking 39 and a shot bird's-eye view image 40 are arranged and displayed instead of the covered distance ranking 34 and the sprint ranking 35 in the display state in FIG. 4. In a case where a coach frequently checks the number of shots and situations at times of shots, for example, it is conceivable, as illustrated in FIG. 13, to automatically perform an arrangement change where an image relating to information that the coach refers to more frequently instead of information that the coach refers to less frequently.

In addition, in a case where there is a significant change in information to be presented, it is also conceivable to display the information in such a way as to attract attention to the significant change.

For example, FIG. 13 illustrates an example in which a portion of the formation information 32 corresponding to the opposing team is highlighted or blinked in response to a change in the formation of the opposing team.

As a result, a coach or the like can easily notice changes in a match situation.

Such highlighting can also be applied to the exercise load information 33. In a case where a slope of a cumulative exercise load line of a certain player suddenly becomes larger than before, for example, it can be considered that some abnormality has occurred in the player. It is therefore preferable to highlight or blink the cumulative exercise load line of the player so that a coach can recognize the situation.

The above-described processing of changing a display state of the analysis dashboard 30 may be performed under the control of the server device 2, or may be performed as processing corresponding to a user interface on the terminal device 5. For example, the highlighting or the blinking can be achieved by the server device 2 generating information for display including information subjected to the highlighting or the like for predetermined content in step S157 in FIG. 10 and transmitting the information to the terminal device 5 in step S158.

### 5. Analysis and Display of Players' Fields of View

Next, an analysis and display of the players' fields of view will be described.

By obtaining skeleton capture data, a head swing motion of each player can be detected. In soccer, it is important for players to check surrounding situations, that is, positions and movements of teammates and opposing players, and search for a pass course or the like. Information regarding how much each player is checking surroundings, therefore, is an important factor for coaching.

A visible range and a blind spot, therefore, are visualized for each player. More specifically, it is conceivable to detect the number, directions, and angles of swings of each player's head and aggregate and visualize the data.

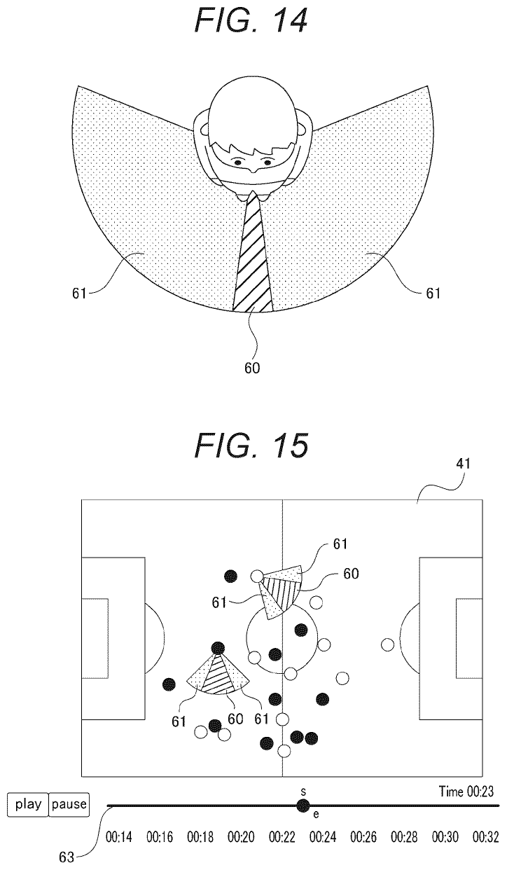

FIG. 14 is an example of the visualization. Central fields of view 60 and peripheral fields of view 61 are displayed, for example, in different colors, different levels of luminance, or the like for different players.

The central field of view 60 is a range in which an object can be clearly perceived, and the peripheral field of view 61 is a range in which an overall image can be vaguely perceived.

As a display mode of the actual analysis dashboard 30, for example, an example where field of view information 41 is displayed as illustrated in FIG. 15 is possible. In the field of view information 41, the central field of view 60 and the peripheral field of view 61 are displayed for each player for each time point in a match.

Note that white circles indicate the players of the own team, and black circles indicate the player of the opposing team. It is assumed in practice that each player is identified by displaying a uniform number in a circle indicating the player.

A time bar 63 indicates time elapsed since a start of the match, and, in response to a certain player swinging his/her head at a certain time point, the central field of view 60 and the peripheral field of view 61 may be displayed in the field of view information 41 as an animation image.

Note that the field of view may be displayed, for example, for all the players, or may be displayed only for a selected player (a player clicked on a screen).

A swing of each player's head can be estimated from the skeleton capture data. The presentation information generation unit 22 of the server device 2, therefore, can determine a swing of each player's head on the basis of the skeleton capture data and generate information for displaying the field of view information 41 in step S157 of FIG. 10.

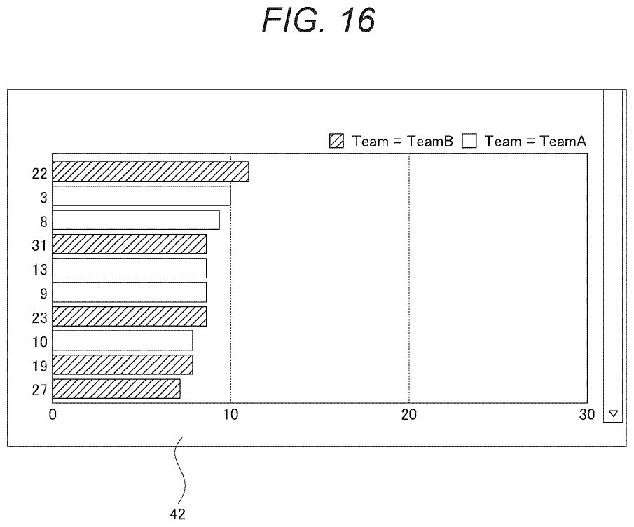

FIG. 16 illustrates a swing ranking 42 that can be displayed in the analysis dashboard 30. A horizontal axis represents the number of swings of the head, and a vertical axis represents each player. A value on the vertical axis is the uniform number of each player, but a name may be displayed, instead.

By counting the number of swings of each player's head and displaying a ranking like this, it becomes easy to understand players who check their surroundings well and players who do not check much.

It is conceivable that the displayed swing ranking 42 is sequentially updated in accordance with swings of each player's head detected during the match.

It is assumed that the presentation information generation unit 22 of the server device 2 determines swings of each player's head on the basis of the skeleton capture data and updates information in the swing ranking 42 in step S157 in FIG. 10.

### 6. Conclusion and Modifications

According to the above embodiment, the following effects can be produced.

The information processing device 70 that functions as the server device 2 according to the embodiment includes the exercise load calculation unit 21 that performs processing of calculating a value of an exercise load of a player on the basis of a subject generated from an image captured by the imaging device 10, that is, skeleton capture data regarding the player (refer to FIGS. 2 and 6 to 10).

For example, by obtaining skeleton capture data as EPTS data, a motions and a posture of a player can be determined in detail. As a result, a value of an exercise load can be calculated according to the motion and the posture. There is also a method for simply estimating and calculating an exercise load from a covered distance, for example, but in the processing according to the present embodiment, it is possible to obtain an accurate exercise load that reflects an actual exercise mode more closely.

Note that the description has been given while assuming soccer players as subjects from which skeleton capture data is obtained, but the present invention can also be applied to exercise loads of players of a sport other than soccer. The present invention can also be applied to estimation of exercise loads of ordinary people in daily life activities. Furthermore, the calculation of an exercise load based on skeleton capture data can be performed for not only a person but also an animal. For example, a racehorse may be a target, instead.

In addition, although the embodiment has been described while assuming the information processing device 70 that performs cloud computing as the server device 2, a device other than the server device 2 may perform the processing for providing analysis information for the terminal device 5, instead. It is also conceivable, for example, that an information processing device that controls the imaging device 10 installed in a match venue or the terminal device 5 performs the processing of calculating a value of an exercise load of a player and the processing of presenting the value of the exercise load.

In the embodiment, an example has been described in which the exercise load calculation unit 21 estimates an exercise mode of a subject from skeleton capture data and calculates a value of an exercise load of the subject on the basis of a reference value of the amount of exercise according to the estimated exercise mode (refer to FIGS. 6 to 10).

In a case where a motion and a posture of a player can be determined in detail by obtaining skeleton capture data, a type of exercise performed in a certain period can be estimated. By estimating an exercise mode, that is, a type of exercise performed, and calculating a value of an exercise load using a reference value of the amount of exercise according to the exercise mode, that is, for example, a reference value of METS, therefore, an exercise load according to the type of exercise can be calculated more accurately.

In the embodiment, it has been described that the exercise load calculation unit 21 estimates a running speed of a subject as an exercise mode.

An exercise load of a player is completely different depending on whether the player is sprinting or running slowly. That is, a difference in running speed can be regarded as a difference in a type (mode) of exercise. By converting the reference value of METS according to the difference in running speed into an exercise load, a more accurate exercise load can be obtained than in a case where an exercise of “running” is simply detected.

In the embodiment, it has been described that the exercise load calculation unit 21 estimates a jumping motion of a subject as an exercise mode.

An exercise load in a case where a player jumps to head a ball or the like is different from ones in states of other exercise modes. By estimating a jump and obtaining an exercise load using a reference value corresponding to the jump, a more accurate exercise load can be calculated.

In the embodiment, it has been described that the exercise load calculation unit 21 estimates a contact of a subject with another person as an exercise mode.

An exercise load in a case where a player collides with or comes into contact with another player or a case where a player falls down is different from ones in other exercise modes. By estimating one of these contact states and obtaining an exercise load using a reference value corresponding to the contact state, a more accurate exercise load can be calculated.

In the embodiment, it has been described that the exercise load calculation unit 21 obtains weather information at a location a subject and performs the processing of correcting a value of an exercise load calculated for the subject using the weather information (refer to FIGS. 6 to 10).

Temperature and humidity during a match affect exercise loads of players. By correcting a value of an exercise load calculated on the basis of a motion of a player based on skeleton capture data in accordance with temperature and humidity at a match venue, it is possible to obtain a more actual exercise load.

In the embodiment, an example has been described in which the exercise load calculation unit 21 obtains condition information regarding a subject and performs the processing of correcting a value of an exercise load calculated for the subject using the condition information regarding the subject (refer to FIGS. 6 to 10).

Conditions of individual players also affect exercise loads during a match. The condition includes, for example, sleep time, accumulation of fatigue due to a past match schedule, and the like. Such a condition differs between individual players. A value of an exercise load calculated for each player, therefore, is corrected in accordance with condition information regarding the player. As a result, a more accurate exercise load can be obtained.

Note that in the embodiment, a calculated value of an exercise load is corrected using weather information and condition information, but an example in which such correction is not performed is also conceivable. Even if the correction is not performed, a value of an exercise load that is accurate to some extent is obtained by calculating the value of the exercise load in accordance with an exercise mode.

In addition, although both the correction processing and the setting of the offset OF are performed in the embodiment, it is conceivable, for example, that the correction is not performed and the weather information and the condition information are reflected only in the offset OF.

Of course it is expected that a more accurate value of an exercise load can be obtained by performing the correction processing or both the correction processing and the setting of the offset OF.

In the embodiment, an example has been described in which the exercise load calculation unit 21 sequentially calculates values of an exercise load for a competitor who is a subject between a start and an end of a competition (refer to FIG. 10).

For example, an exercise load of each player is sequentially calculated at predetermined time intervals or the like during a match. As a result, an accurate exercise load in each period during a match can be obtained.

The information processing device 70 that functions as the server device 2 according to the embodiment includes the storage control unit 23 that performs processing of storing values of exercise loads of subjects sequentially calculated by the exercise load calculation unit 21 (refer to FIGS. 2 and 6 to 10).

For example, an exercise load of each player is sequentially calculated during a match, and the storage control unit 23 sequentially stores the exercise load. As a result, it is possible to determine a cumulative exercise load of each player during a match.

The information processing device 70 that functions as the server device 2 according to the embodiment includes the presentation information generation unit 22 that generates presentation information which reflects values of exercise loads of subjects calculated by the exercise load calculation unit 21 (refer to FIGS. 2 and 6 to 10).

For example, the presentation information generation unit 22 generates information that enables presentation of an exercise load of each player during a match and transmits the information to the terminal device 5. The presentation information generation unit 22 may generate an image itself to be presented and transmit the image to the terminal device 5 to display the image. Alternatively, the presentation information generation unit 22 may generate and transmit transmission information including exercise loads to be presented and generate and display an image in accordance with the information received by the terminal device 5.

As a result, the terminal device 5 can display states of cumulative exercise loads during a match in order to help a coach or the like recognize states of players. More specifically, effective information can be presented by displaying the exercise load information 33 in the analysis dashboard 30.

The presentation information according to the embodiment includes information regarding cumulative exercise loads of subjects from a start of a competition. That is, the presentation information is the exercise load information 33 (refer to FIG. 5).

The presentation information generation unit 22 can display a state of an accumulated exercise of each player during a match load up to the present time as the exercise load information 33 illustrated in FIG. 5 by transmitting information that can indicate information regarding the accumulated exercise load. As a result, a staff member such as a coach can intuitively understand a situation of each player during the match.

The presentation information exemplified in the embodiment, that is, the exercise load information 33 in FIG. 5, includes information for presenting whether or not a cumulative exercise load of a subject from the match start time tS is in the high-load state.

The presentation information generation unit 22 can present the high-load lines thP1 and thP2 as illustrated in FIG. 5, for example, by transmitting information that serves as thresholds for a determination as to the high-load state of each player. As a result, a coach or the like can easily determine the high-load state for each player and use the high-load state for a change of players or the like.

Note that various display modes for presenting the high-load state can be considered other than the high-load lines thP1 and thP2. A mode such as a gauge for each player may be used, or a lamp, an alert, or the like may be displayed for each player.

The presentation information exemplified in the embodiment, that is, the exercise load information 33 in FIG. 5, includes prediction information regarding cumulative exercise loads of subjects until an end of a competition.

The presentation information generation unit 22 transmits information that can indicate prediction of a cumulative exercise load of each player until an end of a match, and the exercise load information 33 including the prediction can be displayed in a mode such as the prediction line YL in FIG. 5. As a result, a staff member such as a coach can determine a condition of each player until the end of the match.

In the embodiment, an example has been described in which prediction information is generated on the basis of the amount of change in cumulative exercise loads of subjects from a start of a competition to the present time (refer to FIG. 11).

Prediction information can be easily generated and presented in accordance with a current match by generating information regarding a prediction line YL through extrapolation or the like using the amount of change in a cumulative exercise load of a player from a start of a match to the present time, that is, a slope of a solid line portion in the graph of FIG. 11.

In the embodiment, an example has been described in which prediction information is generated on the basis of cumulative exercise loads of subjects in past competitions (refer to FIG. 12).

For example, information regarding a prediction line YL according to actual exercise loads of each player can be generated and presented using an average value of exercise load lines in past matches of the player.

The information for displaying the exercise load information 33 in FIG. 5 exemplified in the embodiment includes an offset value given to a value of a cumulative exercise load at a start of a competition (refer to FIG. 9).

An offset value is set for each player, for example, in a case where the presentation information generation unit 22 transmits information that can indicate information regarding a cumulative exercise load of the player during a match. In the case of the player P2 in FIG. 5, for example, a load corresponding to the offset is already given at the start of the match. By setting such an offset in accordance with condition information, for example, it is possible to present a cumulative exercise load according to a condition of each player.

The presentation information in the embodiment includes information regarding recognition ranges of subjects.

The presentation information generation unit 22 determines presence or absence of swings of each player's head during a match and ranges and directions of the swings, and information regarding a recognition range, which indicates how much the player recognizes surroundings, can be transmitted. A staff member such as a coach can then understand how each player has recognized the surroundings during the match by, for example, displaying the information as in FIGS. 14 and 15.

In addition, a tendency of each player in the recognition of the surroundings can be grasped by displaying information as illustrated in FIG. 16.

Although the processing such as the calculation of an exercise load and the detection of swings of the head is performed in real time during a match in the embodiment, for example, the processing may be performed after a match, for example, using a recorded video of the match, weather information of a match day, condition information, and the like. It is also possible, for example, to present the analysis dashboard 30 including the exercise load information 33, the field of view information 41, and the like for a past match.

The program according to the embodiment is a program for causing, for example, a CPU, a digital signal processor (DSP), an AI processor, or the like, or the information processing device 70 including the CPU, the DSP, the AI processor, or the like, to perform the processing illustrated in FIGS. 7 to 10.

That is, the program according to the embodiment is a program for causing the information processing device 70 to perform exercise load calculation processing of calculating a value of an exercise load of a subject on the basis of skeleton capture data regarding the subject generated from an image captured by the imaging device 10.

With such a program, the information processing device 70 constituting the information analysis system 1 according to the embodiment can be achieved in, for example, a computer device, a mobile terminal device, or another device capable of performing information processing.

Such a program may be stored in advance in an HDD as a storage medium built in a device such as a computer device, a ROM in a microcomputer including a CPU, or the like.

Alternatively, the program may be temporarily or permanently stored (recorded) in a removable storage medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable storage medium may be provided as so-called package software.

In addition, such a program may be installed from the removable storage medium into a personal computer or the like, or may be downloaded from a downloading site over a network such as a local area network (LAN) or the Internet.

In addition, such a program is suitable for providing the information processing device 70 constituting the information analysis system 1 according to the embodiment in a wide range. By downloading the program to a mobile terminal device such as a smartphone or a tablet, an imaging device, a mobile phone, a personal computer, a gaming device, a video device, a personal digital assistant (PDA), or the like, for example, the smartphone or the like can function as the information processing device 70 constituting the information analysis system 1 in the present disclosure.

Note that the effects described herein are only examples, and effects in the present technology are not limited to these. Other effects may also be produced.

Note that the present technology may also employ the following configurations.

(1)

An information processing device including:
an exercise load calculation unit that performs processing of calculating a value of an exercise load of a subject on the basis of skeleton capture data regarding the subject generated from an image.

(2)

The information processing device according to (1), in which
the exercise load calculation unit estimates an exercise mode of the subject from the skeleton capture data and calculates the value of the exercise load of the subject on the basis of a reference value of an amount of exercise according to the estimated exercise mode.

(3)

The information processing device according to (2), in which
the exercise load calculation unit estimates a running speed of the subject as the exercise mode.

(4)

The information processing device according to (2) or (3), in which
the exercise load calculation unit estimates a jumping motion of the subject as the exercise mode.

(5)

The information processing device according to any one of (2) to (4), in which
the exercise load calculation unit estimates a contact of the subject with another person as the exercise mode.

(6)

The information processing device according to any one of (1) to (5), in which
the exercise load calculation unit obtains weather information at a location of the subject and performs processing of correcting the value of the exercise load calculated for the subject using the weather information.

(7)

The information processing device according to any one of (1) to (6), in which
the exercise load calculation unit obtains condition information regarding the subject and performs processing of correcting the value of the exercise load calculated for the subject using the condition information.

(8)

The information processing device according to any one of (1) to (7), in which
the exercise load calculation unit sequentially calculates values of the exercise load for a competitor who is the subject between a start and an end of a competition.

(9)

The information processing device according to any one of (1) to (8), including:
a storage control unit that performs processing of storing values of the exercise load of the subject sequentially calculated by the exercise load calculation unit.

(10)

The information processing device according to any one of (1) to (9), including:
a presentation information generation unit that generates presentation information which reflects the value of the exercise load of the subject calculated by the exercise load calculation unit.

(11)

The information processing device according to (10), in which
the presentation information includes information regarding a cumulative exercise load of the subject from a start of a competition.

(12)

The information processing device according to (10) or (11), in which
the presentation information includes information for presenting whether or not a cumulative exercise load of the subject from a start of a competition is in a high-load state.

(13)

The information processing device according to any one of (10) to (12), in which
the presentation information includes prediction information regarding a cumulative exercise load of the subject until an end of a competition.

(14)

The information processing device according to (13), in which
the prediction information is generated on the basis of an amount of change in the cumulative exercise load of the subject from a start of the competition to present time.

(15)

The information processing device according to (13), in which
the prediction information is generated on the basis of a cumulative exercise load of the subject in a past competition.

(16)

The information processing device according to any one of (10) to (15), in which
the presentation information includes information regarding a cumulative exercise load of the subject from a start of a competition and an offset value given to a value of the cumulative exercise load at the start of the competition.

(17)

The information processing device according to any one of (10) to (16), in which
the presentation information includes information regarding a recognition range of the subject.

(18)

An information processing method including:
by an information processing device,
performing exercise load calculation processing of calculating a value of an exercise load of a subject on the basis of skeleton capture data regarding the subject generated from an image.

(19)

A program causing an information processing device to perform exercise load calculation processing of calculating a value of an exercise load of a subject on the basis of skeleton capture data regarding the subject generated from an image.

(20)

An information analysis system including:
an imaging device; and
an information processing device including an exercise load calculation unit that performs processing of calculating a value of an exercise load of a subject on the basis of skeleton capture data regarding the subject generated from an image captured by the imaging device.

### REFERENCE SIGNS LIST

1 Information analysis system
2 Server device
3 Weather measurement device
4 Sensors
5 Terminal devices
5a Display unit
6 Terminal devices
10 Imaging device
11 Recording unit
12 EPTS data generation unit
21 Exercise load calculation unit
22 Presentation information generation unit
23 Storage control unit
30 Analysis dashboard
33 Exercise load information
70 Information processing device
71 CPU

1. An information processing device comprising:
an exercise load calculation unit that performs processing of calculating a value of an exercise load of a subject on a basis of skeleton capture data regarding the subject generated from an image.

2. The information processing device according to claim 1, wherein
the exercise load calculation unit estimates an exercise mode of the subject from the skeleton capture data and calculates the value of the exercise load of the subject on a basis of a reference value of an amount of exercise according to the estimated exercise mode.

3. The information processing device according to claim 2, wherein
the exercise load calculation unit estimates a running speed of the subject as the exercise mode.

4. The information processing device according to claim 2, wherein
the exercise load calculation unit estimates a jumping motion of the subject as the exercise mode.

5. The information processing device according to claim 2, wherein
the exercise load calculation unit estimates a contact of the subject with another person as the exercise mode.

6. The information processing device according to claim 1, wherein
the exercise load calculation unit obtains weather information at a location of the subject and performs processing of correcting the value of the exercise load calculated for the subject using the weather information.

7. The information processing device according to claim 1, wherein
the exercise load calculation unit obtains condition information regarding the subject and performs processing of correcting the value of the exercise load calculated for the subject using the condition information.

8. The information processing device according to claim 1, wherein
the exercise load calculation unit sequentially calculates values of the exercise load for a competitor who is the subject between a start and an end of a competition.

9. The information processing device according to claim 1, comprising:
a storage control unit that performs processing of storing values of the exercise load of the subject sequentially calculated by the exercise load calculation unit.

10. The information processing device according to claim 1, comprising:
a presentation information generation unit that generates presentation information which reflects the value of the exercise load of the subject calculated by the exercise load calculation unit.

11. The information processing device according to claim 10, wherein
the presentation information includes information regarding a cumulative exercise load of the subject from a start of a competition.

12. The information processing device according to claim 10, wherein
the presentation information includes information for presenting whether or not a cumulative exercise load of the subject from a start of a competition is in a high-load state.

13. The information processing device according to claim 10, wherein
the presentation information includes prediction information regarding a cumulative exercise load of the subject until an end of a competition.

14. The information processing device according to claim 13, wherein
the prediction information is generated on a basis of an amount of change in the cumulative exercise load of the subject from a start of the competition to present time.

15. The information processing device according to claim 13, wherein
the prediction information is generated on a basis of a cumulative exercise load of the subject in a past competition.

16. The information processing device according to claim 10, wherein
the presentation information includes information regarding a cumulative exercise load of the subject from a start of a competition and an offset value given to a value of the cumulative exercise load at the start of the competition.

17. The information processing device according to claim 10, wherein
the presentation information includes information regarding a recognition range of the subject.

18. An information processing method comprising:
by an information processing device,
performing exercise load calculation processing of calculating a value of an exercise load of a subject on a basis of skeleton capture data regarding the subject generated from an image.

19. A program causing an information processing device to perform exercise load calculation processing of calculating a value of an exercise load of a subject on a basis of skeleton capture data regarding the subject generated from an image.

20. An information analysis system comprising:
an imaging device; and
an information processing device including an exercise load calculation unit that performs processing of calculating a value of an exercise load of a subject on a basis of skeleton capture data regarding the subject generated from an image captured by the imaging device.
